(19) United States
(12) Patent Application Publication
(10) Pub. No.: US 2009/0107569 A1
(43) Pub. Date: Apr. 30, 2009

(54) Valve having a rotary slide

(75) Inventors: Martin Staudinger, Ettlingen (DE); Felix Dreher, Staufen im Breisgau (DE); Sven-Jostein Kro, Hovsherad (NO)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 12/283,138

(22) Filed: Sep. 8, 2008

Related U.S. Application Data
(63) Continuation of application No. PCT/DE2007/000291, filed on Feb. 15, 2007.

(30) Foreign Application Priority Data
Mar. 8, 2006 (DE) 10 2006 010 612.1

(51) Int. Cl. F16K 11/074

(52) U.S. Cl. 137/625.21

(57) ABSTRACT

Valve with a rotary slide. The rotary slide comprises a conduction chamber, which is connected to a first infeed and can optionally be connected to one of a plurality of outlets by changing the rotational position. The rotary slide is designed so that the when pressure is applied the area ratios ensure that a partial pressure equalization always takes place.

The present invention relates to a valve with a rotary slide, and to the use of a valve with a rotary slide.

In hydraulically shifted transmissions, normally one of a plurality of hydraulic cylinders is to be subjected to a hydraulic pressure while the other cylinders remain unpressurized. The hydraulic cylinders are normally combined by pairs into double cylinders, so that by pressurizing the cylinders alternately the pistons can be moved to a middle position or to one of two end positions.

The object of the present invention is to provide a valve for use with such a hydraulically operated shift transmission.

This problem is solved by a valve with a rotary slide, where the rotary slide includes a conduction chamber which is connected to a first infeed in every rotational position of the rotary slide, and by changing the rotational position can be connected optionally to one of a plurality of outlets. The conduction chamber is preferably connected to the first infeed in every rotational position of the rotary slide, but can also be connected to the first infeed only in selected rotational positions.

A refinement provides that the valve includes a second infeed, which is connected to a free space between a valve housing and the rotary slide. Preferably there is a provision that the outlets which are not connected through the conduction chamber to the first infeed in the particular rotational position of the rotary slide are connected through the free space to the second infeed. A refinement provides that the rotary slide has a radial bearing surface, with the radial bearing surface being connected hydraulically to the first infeed by at least one bore.

A refinement provides that the bore is an equalizing port between the radial bearing surface and the conduction chamber. The rotary slide preferably includes a bearing disk, with a drive shaft on one side of the bearing disk and the radial bearing surface on the side with the drive shaft, and a valve slide on the side of the bearing disk facing away from the drive shaft.

The valve slide preferably includes at least one area that projects radially outwardly beyond the radial bearing surface. The production chamber is preferably an essentially radially running groove in the valve slide. The valve slide preferably has an essentially rectangular outline, which projects radially outwardly beyond the radial bearing surface on at least one side, and with the bearing disk projecting radially outwardly beyond the valve slide transversely to that side. A refinement provides that the valve slide projects radially outwardly beyond the radial bearing surface on two opposite sides, and that the bearing disk projects radially outwardly beyond the valve slide transversely to those sides.

A refinement provides that a gap remains between the at least one area of the valve slide that projects radially outwardly beyond the radial bearing surface and a valve housing.

A refinement provides that the valve includes a plurality of outlets, which are arranged so that they are each covered in one rotational position of the rotary slide by one of the two areas of the valve slide that project radially outwardly beyond the radial bearing surface, and are hydraulically connected to the first infeed through the conduction chamber. Preferably it is provided that the outlets are situated so that in each case only exactly one of the outlets is covered by the valve slide in various rotational positions.

The problem named at the beginning is also solved by using a valve according to the invention in a hydraulic system of a hydraulic shift transmission.

Exemplary embodiments of the invention will now be explained on the basis of the accompanying drawings. The figures show the following:

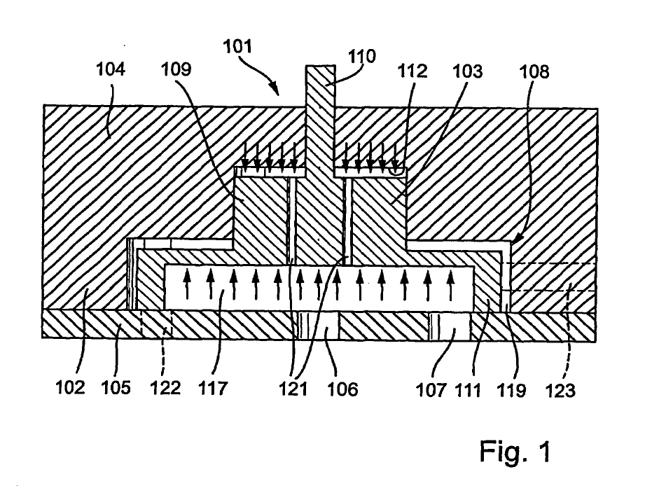

FIG. 1 a schematic depiction of an exemplary embodiment of a rotary valve in cross section;

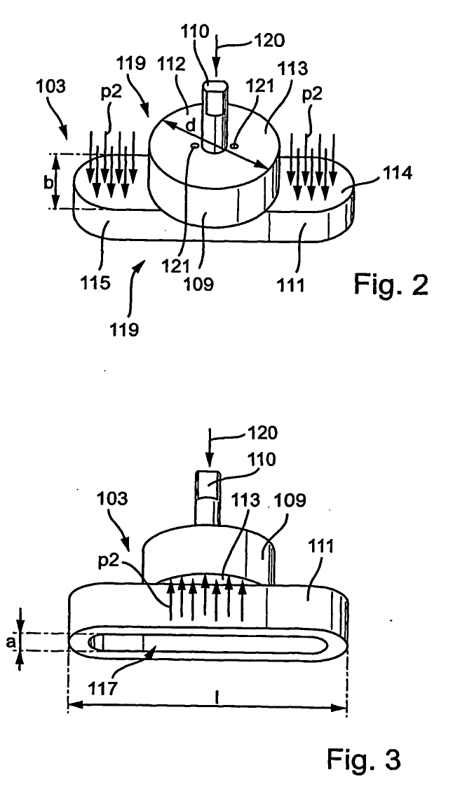

FIG. 2 an exemplary embodiment of a rotary slide in a three-dimensional view;

FIG. 3 the exemplary embodiment according to FIG. 2 in a different view;

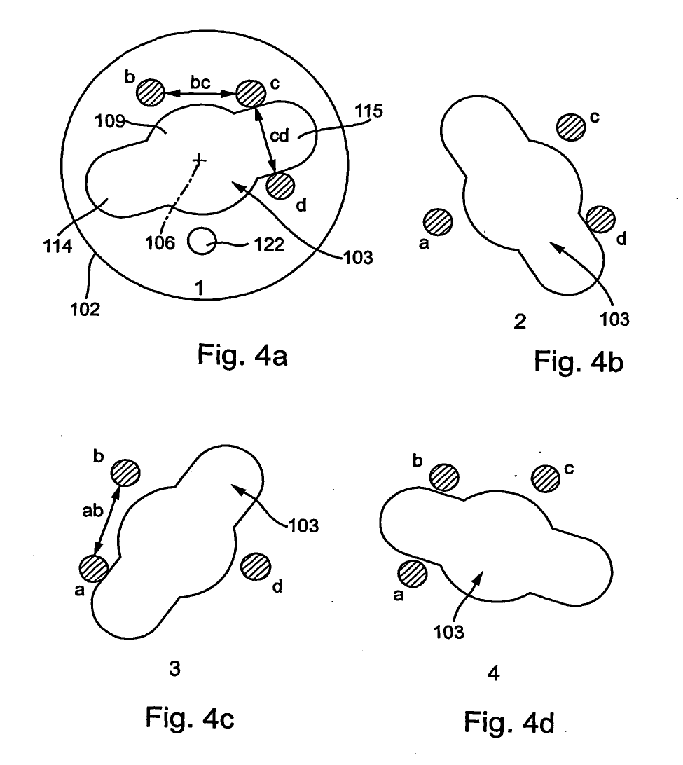

FIG. 4 a schematic depiction of an exemplary embodiment of a rotary valve according to the invention in top view;

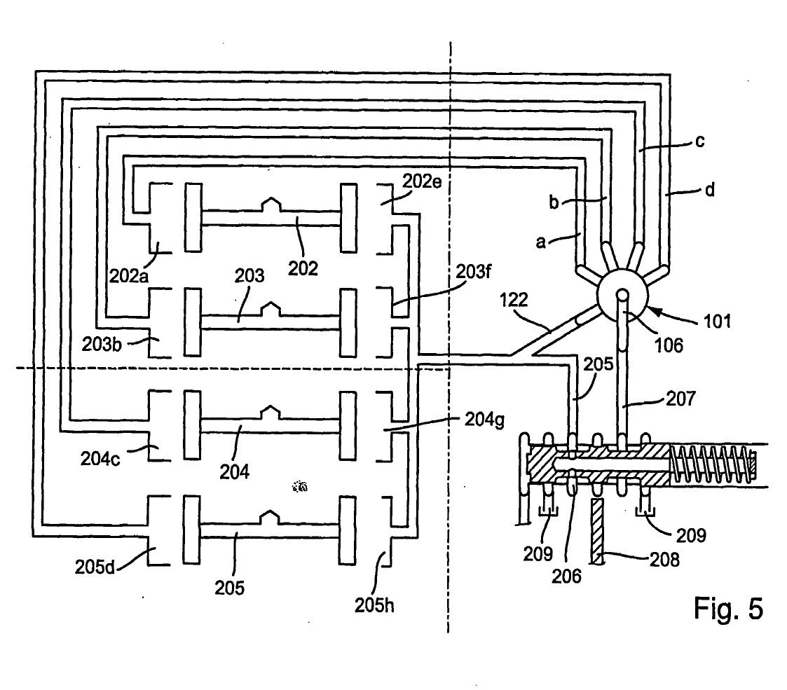

FIG. 5 a schematic depiction of an example of a use of a rotary valve according to the invention in a hydraulic system.

FIG. 1 will be referred to first. This shows a schematic sketch of an exemplary embodiment of a valve 101 according to the invention. This includes a valve housing 102 in which a rotary slide is situated. The rotary slide is depicted from different perspectives in FIGS. 2 and 3. Valve housing 102 comprises an upper housing part 104 and a lower housing part 105. Lower housing part 105 is provided with a first infeed 106, a second infeed 122 and a plurality of outlets 107. Between the valve housing 102 and the rotary slide 103 is a free space 119. Second infeed 122 is constantly connected to the free space 119 between a valve housing 102 and the rotary slide 103. To receive rotary slide 103, a stepped hole 108 is made from below in upper housing part 104, with lower housing part 105 positioned against it. Stepped hole 108 receives rotary slide 103, stepped hole 108 being sealed off from the outside by lower housing part 105, so that hydraulic fluid can only get into stepped hole 108 through the first infeed 106, the second infeed 122 and the outlets 107.

FIG. 2 shows rotary slide 103 in a three-dimensional depiction. This part includes an essentially cylindrically shaped bearing disk 109, on one side of which a drive shaft 110 is centered and on the other side of which a valve slide 111 is situated. Bearing disk 109 includes a radial bearing surface 112 as well as a surface 113 situated on the side opposite the bearing disk, the radial bearing surface 112 being on the side on which the drive shaft 110 is situated and the surface 113 on the side on which the valve slide 111 is situated. The valve slide has an essentially rectangular shape, while the areas 114 and 115 which project radially outwardly from the direction of drive shaft 110 in the top view can be rounded off at the outer margin. The part of stepped hole 108 that is not occupied by valve slide 111 in its particular rotational position is part of the free space 119. The free space 119 thus comprises all the volumes of stepped hole 108 that are not filled by the rotary slide 103. Bearing disk 109 and valve slide 111 may be manufactured in a single piece, or may be joined by welding or by threaded connection. The width b of valve slide 110 is less than the diameter d of bearing disk 109, so that the area 113 of bearing disk 109 projects radially outwardly beyond the sides of valve slide 111. The length l of valve slide 111 is greater than the diameter d of bearing disk 109, so that valve slide 111 projects radially outwardly beyond bearing disk 109 on both sides. Alternatively, valve slide 111 may be designed so that it projects outwardly beyond bearing disk 109 on only one side, so that it terminates for example on one side flush with the outside contour of bearing disk 109 and projects beyond it only on the other side, hence in principle as if one were to displace valve slide 111 radially in one direction in the depiction in FIGS. 2 and 3. On its side facing away from bearing disk 109, valve slide 111 includes a conduction chamber 117, which is formed in the manner of a groove in the side that faces lower housing part 105 in the installed position.

FIGS. 4a-4d illustrate the arrangement of the outlet holes. These are situated radially outside of the bearing disk 109 and radially inside of the area traversed by the conduction chamber when rotary slide 103 is turned. Due to different rotational positions of the rotary slide according to the depictions in FIGS. 4a-4d, there is thus one outlet (these are given the reference labels a, b, c and d in FIG. 4 and correspond to the outlet with the reference label 107 in FIG. 1) connected hydraulically to conduction chamber 117 in each case. Infeed 106 is not depicted in FIG. 4; it is located axially concentrically below drive shaft 110, so that infeed 106 is connected to conduction chamber 117 in every rotational position of rotary slide 103. The outlets 107 designated with the reference labels a, b, c and d in FIG. 4 are all arranged at an angle to each other relative to the axis of rotation of rotary slide 103 marked by drive shaft 110, such that in each case only exactly one infeed can be covered by conduction chamber 117. Since the side of conduction chamber 117 assigned to the outer parts of the areas 114 or 115 can always be made to coincide with one of the outlet holes a, b, c or d, in each case a maximum of only one outlet a, b, c, d needs be passed over in order to be able to reach any other outlet a, b, c, d, as can be seen from FIG. 4. To that end, the outlets a, b, c, d are preferably arranged in a circle, with the center point at the axis of rotation of rotary slide 103 (marked by the drive shaft 110 in FIG. 2), so that the minimal distances between the outer edges of the outlets a, b, c, d designated by ab, bc and cd are larger than the width a of conduction chamber 117. When rotary slide 103 is rotated, there is thus no area in which adjacent outlets a, b, c or d are connected with each other through conducting chamber 117. When arranging the outlets a, b, c and d, care must be taken that none of the outlets are located opposite each other relative to the circle center point M, or in an area in which when one outlet is covered the opposite area of conduction chamber 117 in reference to the center point M comes to cover or partially cover the opposing outlet. This ensures that there is no rotational position of rotary slide 103 in which two or more outlets are connected simultaneously to conduction chamber 117; that is, either no outlet a, b, c, d is connected to the conduction chamber or exactly one outlet a, b, c or d is connected to the conduction chamber 117. It also ensures that starting from any desired position of rotary slide 103 in which one of the outlets a, b, c or d is connected to the conduction chamber 117, a maximum of one adjacent outlet a, b, c or d must be passed over in order to reach any other desired outlet a, b, c or d. Since valve slide 111 is symmetrical, it is thus possible from any of the four positions that are usable in practice with a connection via the conduction chamber to one of the outlets a, b, c, d to assume any other of the possible four positions that are usable in practice in a maximum of two steps. For example, if valve slide 111 is in the position according to FIG. 4b, i.e., in which outlet b is connected to conduction chamber 117, in one step counterclockwise a connection of conduction chamber 117 with outlet d is achieved (illustrated in FIG. 4d), or in two steps a connection of conduction chamber 117 with outlet al. as illustrated in FIG. 4a; or also in two steps clockwise a connection is produced between conduction chamber 117 and outlet c (illustrated in FIG. 4c). It is therefore not necessary to also pass over b and c to switch from a to d; that makes it possible to shorten the maximum switching time.

As depicted in FIG. 1, a gap 119 remains between the valve slide 111 and the upper housing part 104. If stepped hole 108 is subjected to pressure, designated here as pressure p2, this results in a pressure stress on rotary slide 103 according to the arrows p2 in FIGS. 2 and 3. This pressure p2 acts on the one hand on the surfaces of the areas 114 and 115 of valve slide 111 that project radially outward beyond bearing disk 109, and at the same time on the part of the area 113 of bearing disk 109 that is not covered by valve slide 111. The two resulting forces work against each other, so that they at least partially cancel each other out. The area ratios are chosen here so that the pressure force exerted on the areas 114, 115 is (slightly) greater, so that the rotary slide is pushed in the direction of arrow 120 in FIGS. 1-3.

Conduction chamber 117 is connected to the radial bearing surface 112 by equalizing ports 121. The pressure that operates in conduction chamber 117 (designated as p1 in FIG. 1) consequently acts simultaneously on the radial bearing surface 112 of bearing disk 109, with the resulting forces acting in opposite directions. The two thus at least partially cancel each other out. Alternatively, infeed 106 can be connected, for example through a supply line or a hole drilled through valve housing 1022, to the area of the stepped hole in which the bearing disk 109 with the radial bearing surface 112 is in the installation position. The equalizing ports 121 can thus also be routed through valve housing 1022 instead of through rotary slide 103.

The arrangement of the second infeed 122 is depicted in FIGS. 4a-4d. It can be located for example on the lower housing part 105, similar to the outlets a through d. Second infeed 122 is situated so that it is not connected to conduction chamber 117 in any of the switching positions in which one of the outlets a through d is operatively connected to first infeed 106. Instead, second infeed 122 is always connected to the free space 119. The outlets that are not connected to conduction chamber 117, i.e., are not covered by valve slide 111, are hydraulically connected through the free space 119 to second infeed 122. Second infeed 122 is thus not connected to conduction chamber 117 in the positions in which one of the outlets a through d is thus covered by the conduction chamber 117, or is operatively connected to it so that hydraulic fluid can flow through conduction chamber 117 into one of the outlets a through d. In this way, those outlets that are not hydraulically connected to conduction chamber 117 at the moment can be subjected to a different pressure than that which is present at the first infeed 106, namely the pressure that is present at the second infeed 122. Alternatively, it is possible to arrange the second infeed 122 as indicated by the shading in FIG. 1, so that it is not situated in the lower housing part 105 similar to the first infeed 106 and the outlets 107, but rather is installed for example radially in the housing.

FIG. 5 shows an example of the use of a rotary valve according to the invention in a hydraulic system 201 for switching an 8-gear double-clutch transmission. FIG. 5 depicts only those parts of the hydraulic system 201 that are necessary to shift four double cylinders; these are designated with the reference labels 202, 203, 204 and 205. The double cylinders 202 through 205 are each responsible for shifting two gears; in the depiction in FIG. 1 they engage one gear when moved to the left and engage the other gear when moved to the right, and in the middle position, as depicted in FIG. 5, they are in a neutral position. One of the cylinders of each of the double pistons, designated respectively as 202a, 203b, 204c and 205d, is connected respectively to an output a, b, c or d of the valve 101. The second infeed 122, together with the pistons 202e, 203f, 204g and 205h that are not connected to one of the inputs a through d, is connected to an output 205 of a regulating valve 206. Shifting pressure regulating valve 206 has a second output 207, which is connected to the first input 106 of valve 101. A high pressure input 208 of shifting pressure regulating valve 206 is connected to the pressure side of a pump or pressure reservoir (not shown here); two low pressure inputs 209 of shifting pressure regulating valve 206 are connected to the low pressure side of the hydraulic pump, not shown here, or a hydraulic tank or reservoir for the hydraulic oil (essentially at ambient pressure). Shifting pressure regulating valve 206 has a total of three positions, namely a middle position, in which outputs 205 and 207 are separated from high pressure input 208 and are connected to low pressure inputs 209, a first position, in which output 205 is connected to high pressure input 208 and output 207 is connected to low pressure input 209, and a second position, in which output 207 is connected to high pressure input 208 and output 205 is connected to low pressure input 209. In the three positions, shifting pressure regulating valve 206 can thus either connect neither of the two outputs to one of the inputs, or can alternatively either connect output 205 to high pressure input 208 and output 207 to one of the low pressure inputs 209, or conversely can connect output 207 to high pressure input 208 and output 205 to one of the low pressure inputs 209. Thus high pressure and low pressure can be applied alternately to the outputs 205 and 207.

There are two types of pressure loading. If the high pressure is present as pressure p1 at the first infeed, it operates within valve slide 111 in conduction chamber 117. Because of the equalizing ports, this pressure also acts on the side of the bearing plate facing the drive shaft, on which the valve slide is situated. The areas are designed so that a slight residual force is produced, which presses the valve slide gently onto the lower housing part 105. If the high pressure is present as pressure p2 at the second infeed, the first pressure p1 is inoperative; instead, the second pressure p2 operates between the rotary slide 103 and the valve housing 102. The surfaces that are under pressure at the same time in a particular instance are designed so that there is always a slight residual force present, which presses the rotary slide 103 against the lower housing part in order to achieve a better seal between valve slide 111 and valve housing 102. As a result of the measures named above, the maximum pressure at which the rotary slide 103 can just still be moved can be increased.

Reference Numeral LIst

| | |
|---|---|
| 101 | valve |
| 102 | valve housing |
| 103 | rotary slide |
| 104 | upper housing part |
| 105 | lower housing part |
| 106 | first infeed |
| 107 | outlets (also designated |
| | as a through d) |
| 108 | stepped hole |
| 109 | bearing disk |
| 110 | drive shaft |
| 111 | valve slide |
| 112 | radial bearing surface |
| 113 | surface |
| 114 | area that projects |
| | radially outward |
| 115 | area that projects |
| | radially outward |
| 117 | conduction chamber |
| 118 | gap |
| 119 | free space |
| 120 | directional arrow |
| 121 | equalizing ports |
| 122 | second infeed |

1. A valve having a rotary slide, characterized in that the rotary slide includes a conduction chamber, which is connected to a first infeed and can optionally be connected to one of a plurality of outlets by changing the rotational position.

2. A valve according to claim 1, characterized in that it includes a second infeed, which is connected to a free space between a valve housing and the rotary slide.

3. A valve according to claim 2, characterized in that the outlets which are not connected through the conduction chamber to the first infeed in the particular rotational position of the rotary slide are connected through the free space to the second infeed.

4. A valve according to claim 1, characterized in that the rotary slide has a radial bearing surface, the radial bearing surface being connected hydraulically to the first infeed by at least one bore.

5. A valve according to claim 4, characterized in that the bore is an equalizing port between the radial bearing surface and the conduction chamber.

6. A valve according to claim 1, characterized in that the rotary slide includes a bearing disk, with a drive shaft on one side of the bearing disk and the radial bearing surface on the side with the drive shaft, and a valve slide on the side of the bearing disk facing away from the drive shaft.

7. A valve according to claim 6, characterized in that the valve slide includes at least one area that projects radially outwardly beyond the radial bearing surface.

8. A valve according to claim 1, characterized in that the conduction chamber is a groove running essentially radially in the valve slide.

9. A valve according to claim 6, characterized in that the valve slide has an essentially rectangular outline, which projects radially outwardly beyond the radial bearing surface on at least one side, and in that the bearing disk projects radially outwardly beyond the valve slide transversely to that side.

10. A valve according to claim 9, characterized in that the valve slide projects radially outwardly beyond the radial bearing surface on two opposite sides, and that the bearing disk projects radially outwardly beyond the valve slide transversely to those sides.

11. A valve according to claim 10, characterized in that a gap remains between the at least one area of the valve slide that projects radially outwardly beyond the radial bearing surface and a valve housing.

12. A valve according to claim 6, characterized in that the valve includes a plurality of outlets, which are situated so that each of them is covered in one rotational position of the rotary slide by one of the two areas of the valve slide that project radially outwardly beyond the radial bearing surface, and are connected hydraulically through the conduction chamber to the first infeed.

13. A valve according to claim 12, characterized in that the outlets are situated so that in each case only exactly one of the outlets is covered by the valve slide in various rotational positions.

14. A hydraulic shift transmission having a hydraulic system that includes a valve according to claim 1.
